(19) United States
(12) Patent Application Publication
(10) Pub. No.: US 2026/0188571 A1
(43) Pub. Date: Jul. 2, 2026

(54) MANUFACTURING OF SPATIALLY VARIABLE PERMANENT MAGNET

(71) Applicant: FORD GLOBAL TECHNOLOGIES, LLC, Dearborn, MI (US)

(72) Inventors: Wanfeng Li, Novi, MI (US); Franco Leonardi, Saline, MI (US); Michael W. Degner, Novi, MI (US)

(73) Assignee: FORD GLOBAL TECHNOLOGIES, LLC, Dearborn, MI (US)

(21) Appl. No.: 19/003,001

(22) Filed: Dec. 27, 2024

(51) Int. Cl. H01F 41/02; H01F 7/02

(52) U.S. Cl. CPC H01F 41/0253; H01F 7/021

(57) ABSTRACT

A method for manufacturing a spatially varying permanent magnet with enhanced resistance to demagnetization is provided. The method starts by aligning magnetic particles in a powder form using an alignment fixture. The electromagnet's pole pieces are configured with materials of varying magnetic permeabilities to control the magnetic field's orientation and strength. By adjusting these properties, the magnetic particles are aligned in different regions of the magnetizable material to create spatially varying magnetic properties. Finally, the permanent magnet is formed with at least one inclined easy axis in specific regions, which increases its resistance to demagnetization.

### TECHNICAL FIELD

In at least one aspect, the following is related to the field of permanent magnet manufacturing, and more particularly to methods for producing spatially varying permanent magnets with enhanced resistance to demagnetization. Such magnets are especially useful in high-performance applications, including electric motors, generators, and other devices that require magnets with tailored magnetic field distributions to meet specific design requirements.

### BACKGROUND

Permanent magnets are used in applications like interior permanent magnet (IPM) motors, where they sustain magnetic fields for torque. Methods to achieve spatially varying magnetic properties typically involve altering compositions or combining different materials. In IPM motors, corners of the magnets may be subject to demagnetization due to motor geometry and field direction.

### SUMMARY

In at least one aspect, a method for manufacturing spatially varying permanent magnets using an innovative approach to the powder alignment process is provided. Instead of altering the composition of the magnet, the method involves the use of pole pieces made from materials with different magnetic permeabilities to control the orientation and magnitude of the magnetic field during the alignment of magnet particles. This allows for precise control over the magnetic properties of the resulting magnet, particularly in regions that are prone to demagnetization. By configuring the pole pieces with materials such as iron (Fe), iron-cobalt (FeCo) alloys, and iron-silicon (FeSi) alloys, the method enables the production of permanent magnets with inclined easy axes in selected regions, thereby increasing their resistance to demagnetization. This approach eliminates the need for compositional changes or complex assembly processes, reducing the complexity of manufacturing. The method is particularly advantageous for producing magnets with customized magnetic properties or field distributions, including periodic flux variations, making it ideal for applications requiring enhanced performance in high-stress magnetic environments.

In another aspect, a method for manufacturing a spatially varying permanent magnet with enhanced demagnetization resistance is provided. The method involves placing magnetic particles of a magnetizable material into an alignment fixture positioned between a first magnetic pole piece and a second magnetic pole piece of an electromagnet. At least one of the first or second magnetic pole pieces is configured with regions with spatially varying magnetic permeabilities. The magnetic permeability of the first magnetic pole piece and/or the second magnetic pole piece modifies orientation and magnitude of a magnetic field in in the cavity between the poles in the alignment fixture. By activating the electromagnet, the magnetic particles are aligned along different directions in different regions of the magnetizable material based on the varying orientation and strength of the magnetic field. Finally, the spatially varying permanent magnet is formed.

In another aspect, the methods significantly increase the performance and durability of permanent magnets in demanding applications while also providing an effective and scalable solution for manufacturing magnets with spatially varying properties.

In another aspect, the magnetic permeability of the first magnetic pole piece and/or the second magnetic pole piece is configured with regions in a parallel and/or a serial arrangement to control magnetic field distribution in the alignment fixture.

In another aspect, magnetic particles of a magnetizable material can include magnetic particles with a relatively low magnetic permeability and magnetic particles with a relatively high magnetic permeability, with the magnetic particles with a relatively low magnetic permeability being in specific regions of the alignment fixture to guide magnetic flux along predetermined paths when aligning the magnetic particles.

In another aspect, a fixture for aligning magnetic particles while forming a spatially varying permanent magnet is provided. The fixture comprises an alignment cavity designed to hold magnetizable material in powder form, along with at least one electromagnet having a first magnetic pole piece and a second magnetic pole piece. One or both of these pole pieces are constructed from materials with varying magnetic permeabilities, and they are arranged around the alignment cavity. The first and second magnetic pole pieces are arranged to control orientation and magnitude of the magnetic field within the alignment cavity. This configuration produces a spatially varying magnetic field, resulting in the alignment of magnetic particles with a spatially varying orientation that corresponds to the magnetic field distribution.

In another aspect, a spatially varying permanent magnet is provided. The spatially varying permanent magnet includes a sintered plurality of magnetic particles aligned using an electromagnet with pole pieces configured from materials having spatially varying magnetic permeabilities. In at least one region, the spatially varying permanent magnet has an easy axis inclined by at least 15 degrees, resulting in enhanced demagnetization resistance in the regions exposed to higher demagnetizing fields.

In another aspect, the sintered plurality of magnetic particles include magnetically anisotropic regions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A and 1B. A flow chart depicting a method for manufacturing a spatially varying permanent magnet with enhanced demagnetization resistance.

FIG. 2A. A schematic of a magnetic pole piece for aligning magnetic particles used in a process for forming a permanent magnet.

FIG. 2B. A schematic of a magnetic pole piece for aligning magnetic particles used in a process for forming a permanent magnet.

FIG. 3A. A schematic showing magnetic field directions in the cavity for the configuration of FIG. 2A.

FIG. 3B. A schematic showing magnetic field directions in the cavity for the configuration of FIG. 2B.

FIG. 4A. A schematic of a magnetic pole piece for aligning magnetic particles used in a process for forming a permanent magnet with spatially varying orientation of magnetization direction (or easy axis) as displayed with the arrows.

FIG. 4B. A schematic of a magnetic pole piece for aligning magnetic particles used in a process for forming a permanent magnet with curved surfaces and ring samples.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including” or “comprising.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

The term “easy axis” refers to the preferred direction along which the magnetic moments of a material naturally align in the absence of an external magnetic field. This is due to the material's internal magnetic anisotropy, which means that the material's structure or composition makes it energetically favorable for the magnetic domains to align along this particular axis. When a material has an easy axis, it takes less energy to magnetize it along this direction compared to other directions. In contrast, trying to magnetize the material in a direction different from the easy axis (called a hard axis) would require a much stronger magnetic field. The easy axis is important in permanent magnets because aligning the magnetic moments along this axis enhances the material's resistance to demagnetization and allows it to maintain a stable, strong magnetic field in applications such as motors and sensors.

Abbreviations:

“IPM” means Interior Permanent Magnet.

“FeCo” means iron-cobalt alloy.

“FeSi” means iron-silicon alloy.

In at least one aspect, spatially varying properties can be realized with minimal adjustments to existing manufacturing processes, offering a more effective solution. In contrast, spatially varying magnetic properties in magnets are typically achieved by altering the composition or combining different types and grades of magnets, which are not efficient. While both remanence and coercivity are crucial magnetic properties in most applications, coercivity becomes particularly critical when dealing with spatially varying magnetic properties. When a magnetic field is applied at an inclined angle, a stronger field is required to overcome the magnet's coercivity and induce demagnetization. To enhance the magnet's resistance to demagnetization, regions exposed to higher demagnetizing fields are engineered with an inclined easy axis with respect to the external magnetic field. This strategic design significantly increases the magnet's overall stability. In interior permanent magnet (IPM) motor applications, the corners of the magnet are especially prone to demagnetization, making such optimizations even more essential.

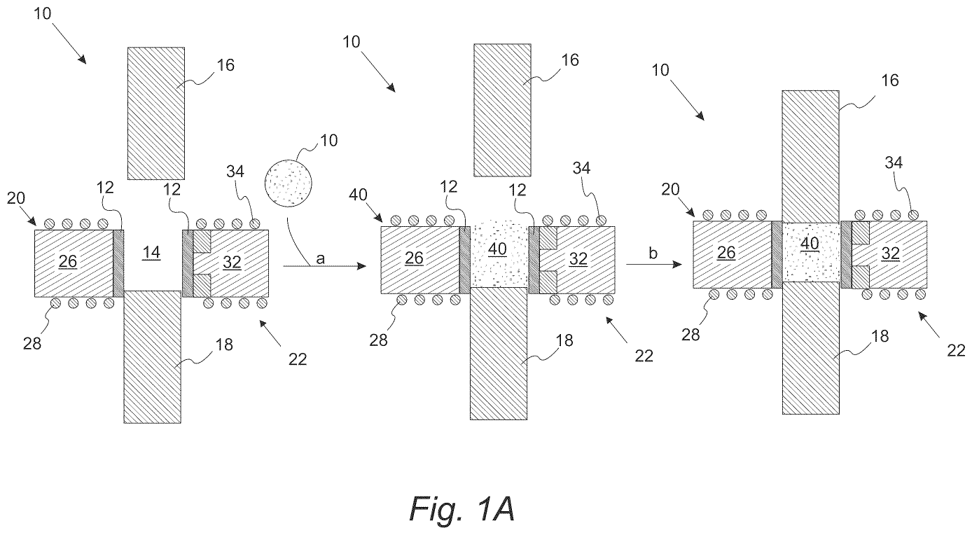

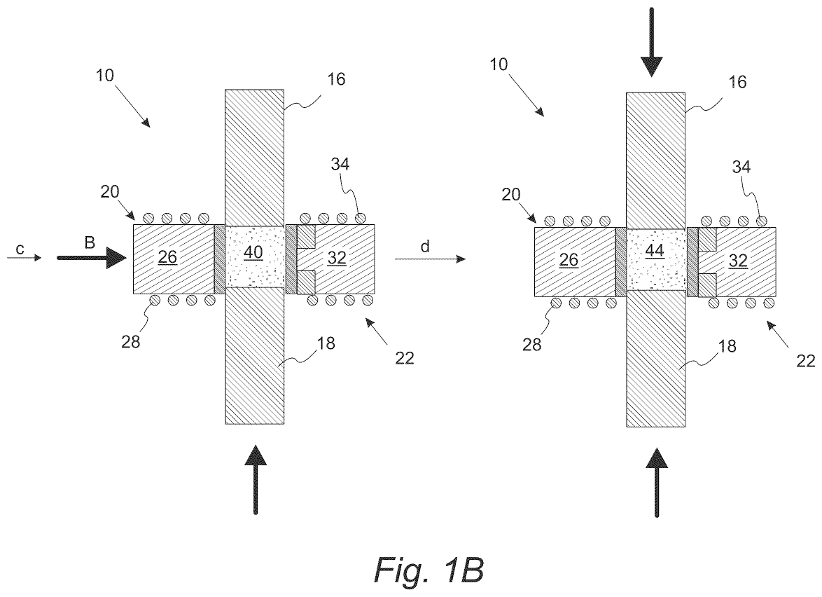

Referring to FIGS. 1A and 1B, a flow chart depicting a method for manufacturing a spatially varying permanent magnet with enhanced demagnetization resistance is provided. In a refinement, the permanent magnet is formed using a sintering process after the alignment of the magnetic particles. Magnetic field press 10 includes an alignment fixture 12 having (e.g., defines) an alignment cavity 14 and punches 16, 18. Electromagnets 20 and 22 are placed at opposite sides of mold alignment cavity 14, with one configured as the north pole and the other as the south pole. This arrangement creates a magnetic field B with lines of force that extend across alignment cavity 14, running from the north pole to the south pole. As described below, a magnetic permeability of the first magnetic pole piece and/or the second magnetic pole piece can be configured with regions in a parallel and/or a serial arrangement to control magnetic field distribution in the alignment fixture. The field is present within the alignment cavity, allowing precise control over the alignment of the magnetic particles as the magnetic flux flows uniformly between the two poles. Electromagnet 20 includes magnetic pole piece 26 (i.e., a magnetic core) surrounded by coil 28. Similarly, electromagnet 22 includes magnetic pole piece 32 (i.e., a magnetic core) surrounded by coil 34. In step a), magnetic particles 40 are loaded into alignment cavity 14 typically at least partially defined by optional alignment fixture 12. Advantageously, magnetic particles of a magnetizable can include magnetic particles with a relatively low magnetic permeability and/or magnetic particles with a relatively high magnetic permeability. In this context, “relatively” mean with respect to each set of particles. As set forth below, magnetic pole piece 32 and magnetic pole piece 32 can include regions with a differing magnetic permeability to guide the magnetic flux along predetermined paths in the forming permanent magnet. In step b), the alignment cavity 14 is closed, typically with punch 16. At least one (or both) of magnetic pole piece 26 of electromagnet 20 and/or magnetic pole piece 32 of electromagnet 22 is configured with materials of varying magnetic permeabilities. The magnetic permeability of the pole piece material is configured to modify the orientation and magnitude of the magnetic field within the alignment fixture, as described below. For example, the first magnetic pole piece 26 and/or the second magnetic pole piece 32 can be configured to generate an inclined magnetic field in selected regions of the alignment cavity with respect to a predetermined plane, resulting in the formation of an inclined easy axis in the spatially varying permanent magnet. In step c), the magnetic particles 40 are aligned in different regions of the magnetizable material by activating electromagnets 20 and 22 according to the orientation and magnitude of the magnetic field generated by electromagnets 20 and 22. This produces an anisotropic permanent magnet 44 with spatially varying magnetic properties. In this regard, first magnetic pole piece 26 and/or the second magnetic pole piece 32 can includes regions with a first magnetic permeability and regions with a second magnetic permeability which can generate a spatially varying magnetic field, particularly a field with varying orientation. In a refinement, the first magnetic permeability is lower than the second magnetic permeability. In step d), the permanent magnet is formed typically with at least one inclined easy axis in one or more regions such that the inclined easy axis increases the magnet's resistance to demagnetization. Typically, the permanent magnet 44 is formed by compressing magnetic particle 40 with punches 16 and 18.

As set forth above, the method produces a spatially varying permanent magnet with enhanced demagnetization resistance. In this context, enhanced demagnetization resistance refers to a magnet's ability to resist demagnetization compared to traditional magnets. A traditional magnet refers to a magnet that has uniform magnetic properties throughout its structure, meaning the magnetic moments or domains are aligned in a single direction (unidirectionally) during its manufacturing process. These magnets are typically produced using common magnetic materials, such as ferrite, neodymium, or alnico, and are created through processes like casting, sintering, or bonding. Traditional magnets are more susceptible to demagnetization, particularly in regions exposed to strong external magnetic fields or mechanical stress. By incorporating spatially varying magnetic properties or an inclined easy axis, the magnet formed by this method is better able to resist demagnetization in these challenging conditions. Furthermore, compared to magnets with uniform magnetic alignment, which are vulnerable to demagnetizing forces in certain areas, the enhanced design distributes the magnetic properties in a way that increases resistance to demagnetization across the magnet. This enhancement ensures more reliable performance, particularly in applications requiring long-term magnetic stability, such as motors, sensors, and other critical magnetic devices. In a refinement, the spatially varying permanent magnet includes inclined easy axis regions such that the spatially varying permanent magnet has a higher magnetic resistance to demagnetization relative to a spatially uniform magnet. In a further refinement, an inclination angle of the inclined easy axis relative to a predefined surface of the permanent magnet is at least 15 degrees. Typically, the predefined surface is a surface facing the first magnetic pole piece and/or the second magnetic pole piece.

In another aspect, the magnetic particles are held in a non-magnetic container that forms part of the alignment fixture. The container is constructed from materials with low or no magnetic permeability, such as stainless steel, ceramic, or plastic, to reduce interference with the magnetic field used for particle alignment. In embodiments involving sintering, the container is designed to be heat-resistant, capable of withstanding high temperatures without deformation or reaction with the particles. The container may be shaped to conform to the geometry of the final magnet, ensuring proper alignment and compaction of the particles prior to bonding or sintering. Furthermore, the container is sufficiently rigid to securely hold the magnetizable powder during the alignment and compaction processes, facilitating the formation of a permanent magnet with spatially varying magnetic properties.

In another aspect, materials used for the pole pieces of the electromagnet are selected based on their magnetic permeability to control the magnetic field distribution within the alignment fixture. Materials with high magnetic permeability, such as iron (Fe) and iron-cobalt (FeCo) alloys, are utilized where strong magnetic field conduction is required to enhance the alignment of magnetic particles. Conversely, materials with low magnetic permeability, such as iron-silicon (FeSi) alloys, soft magnetic composite alloys, or amorphous Fe based alloys, are employed in magnetic regions where more controlled or reduced magnetic field conduction is needed. The permeability of these materials can be controlled not only by composition but also by the manufacturing process. For example, by introducing stress, Fe, FeCo, or FeSi can have lower permeability than the same alloys that have experience stress relief annealing. This strategic use of materials with differing magnetic permeabilities allows for precise manipulation of the magnetic field's magnitude and orientation, ensuring the optimal alignment of magnetic particles and resulting in spatially varying magnetic properties in the finished permanent magnet.

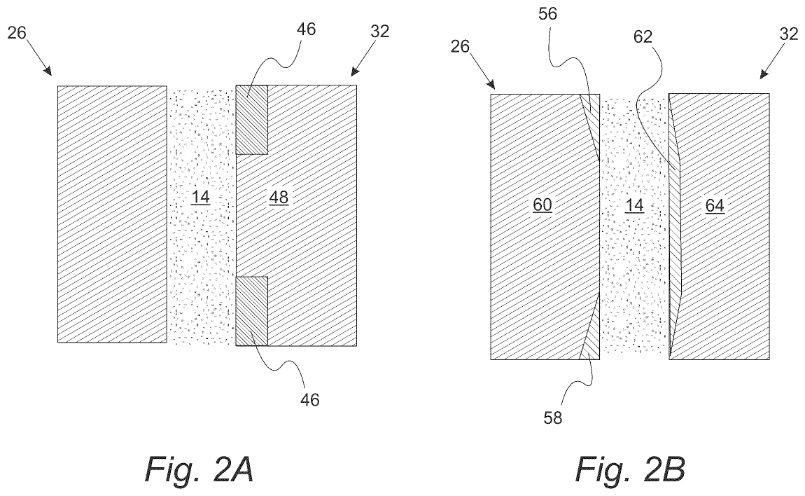

Referring to FIGS. 2A and 2B, schematics of electromagnet pole pieces with spatially varying properties are provided. The magnetic permeability of the pole piece materials is configured in a parallel or serial arrangement to control the magnetic field distribution in the alignment fixture. Such arrangements refers provide the ability to precisely controlling the magnetic field used during the alignment of magnetic particles in the manufacturing of a spatially varying permanent magnet. The pole pieces in the electromagnet, which are responsible for shaping the magnetic field, can be constructed from materials with different magnetic permeabilities. These materials can be arranged either in a parallel or serial configuration within the alignment fixture. A parallel arrangement means that the materials with varying magnetic permeabilities are placed side by side. This allows the magnetic field to be distributed evenly or adjusted to target specific regions within the alignment fixture. The magnetic field can be tailored simultaneously across different paths, which is particularly useful in creating spatially varying magnetic orientations in different parts of the magnet. In contrast, a serial (or series) arrangement places the materials with different permeabilities one after the other in a sequence. As the magnetic field passes through these materials in succession, its strength and orientation can be progressively altered. This allows for more precise control over how the magnetic field affects the alignment of the magnetic particles in different areas of the fixture. By configuring the pole piece materials in either a parallel or serial manner, the method enables the customization of the magnetic field to achieve the desired spatial variation in the alignment of the magnetic particles, ultimately resulting in a permanent magnet with tailored magnetic properties. This feature is critical for applications where specific magnetic field distributions are needed to enhance performance, such as in motors or sensors.

The pole pieces of the alignment electromagnet are designed with regions of varying magnetic permeability to generate a tailored magnetic field within the alignment cavity. By incorporating materials such as Fe, FeCo, and FeSi, each with distinct permeabilities at specific field strengths, the magnetic field can be precisely adjusted in the alignment cavity to control its orientation and magnitude in desired regions. Fe (Iron), FeCo (Iron-Cobalt alloy), and FeSi (Iron-Silicon alloy) are all materials with notable magnetic properties, particularly in terms of their magnetic permeability. Iron (Fe) is well-known for its high permeability (relative permeability typically around 5,000 to 10,000), making it highly effective at conducting magnetic fields. It is widely used in magnetic pole pieces (e.g., magnetic cores), transformers, and electromagnets. FeCo, an alloy of iron and cobalt, exhibits very high permeability (relative permeability in the range of 10,000 to 100,000), often exceeding that of pure iron. This makes it an excellent choice in applications where strong magnetic saturation and performance are critical, such as in high-performance magnets, magnetic sensors, and advanced electromagnetic devices. Finally, FeSi, an iron-silicon alloy, has a low magnetic permeability (relative permeability around 1,000 to 6,0000), with the addition of silicon enhancing its electrical resistivity and reducing energy losses due to eddy currents. FeSi alloys are commonly used in electrical machines and transformers, where both high magnetic permeability and efficiency are required. There are also other soft magnetic materials, such as amorphous and nanocrystalline alloys, soft magnetic composite. Together, these materials offer a range of options for designing components in magnetic field manipulation and energy-efficient devices.

FIG. 2A depicts a variation in which relatively low permeability regions 46 are placed at the edges of electromagnet 32 facing alignment cavity 14. Region 48 of magnetic pole piece 32 is composed of a magnetic material that has a higher magnetic permeability (e.g., FeCo) relative to the magnetic permeability of regions 46 and 48 (e.g., Fe or FeSi). In this section, regions 46 have a rectangular or square cross-section.

FIG. 2B provides an example of electromagnet pole pieces with spatially varying properties. In this variation, both magnetic pole piece 26 and magnetic pole piece 32 include regions of relatively low permeability. In particular, relatively low permeability regions 56 and 58 are placed at the edges of pole piece 26 that are proximate to and facing alignment cavity 14. Region 60 of magnetic pole piece 26 is composed of a magnetic material that has a higher magnetic permeability relative to the magnetic permeability of regions 56 and 58. Relatively low permeability region 62 is positioned along the edge of magnetic pole piece 32 facing alignment cavity 14. In the example depicted, relatively low permeability region 62 has a trapezoidal cross-section. Moreover, section 64 of magnetic pole piece 32 is composed of a magnetic material that has a higher magnetic permeability relative to the magnetic permeability of region 62.

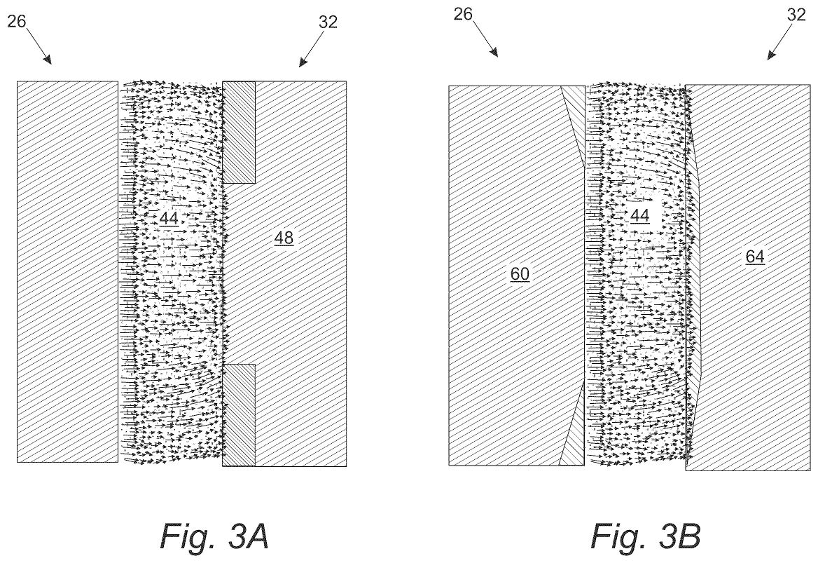

FIGS. 3A and 3D depict the magnetic field direction in the configurations of FIGS. 2A and 2B, respectively. The field orientation can be changed, and the magnetization direction is inclined with respect to a normal to a predetermined surface of the magnet in the top and bottom parts of the magnet. Typically, the predetermined surface can be the surface of pole piece 26 and/or pole piece 32 facing permanent magnet 44 in FIGS. 3A and 3B. An inclination angle larger than 15 degrees is preferable to increase the resistance to demagnetization for IPM applications. Arrows show the magnetic field direction throughout the gap. For different applications, according to design requirement, different materials combinations can be used for the pole piece materials.

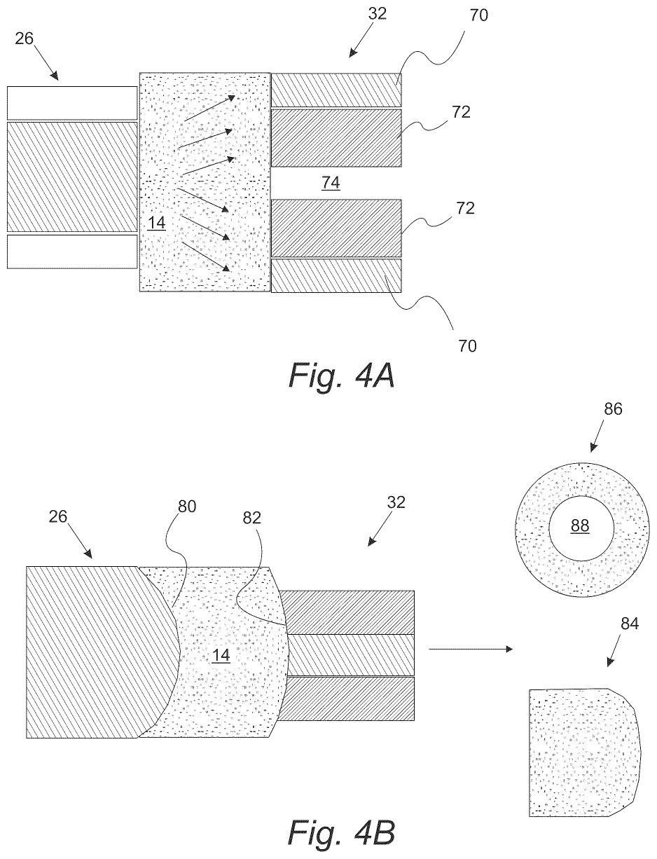

FIGS. 4A and 4B show that magnets with different shapes can be manufactured with spatially varying properties. In these variations, the magnetic field created can be used to either increase the magnetic resistance, modulate the flux density distribution, or both. Moreover, the alignment cavity 14 can be designed to accommodate different magnet shapes and sizes, allowing formation of magnets with varied geometries and spatially tailored magnetic properties. The field variation can also be periodic, for example, to create sinusoidally varying flux by the magnet. In this regard, the first magnetic pole piece 26 and/or the second magnetic pole piece 32 are configured to create a periodically varying magnetic field in the alignment cavity 14, thereby producing a sinusoidal or other periodic flux variation in the aligned magnetic particles and a permanent magnet with a sinusoidal variation in flux density.

FIG. 4A depicts a configuration in which magnetic pole piece 32 includes peripheral relatively high magnetic permeability region 70 (e.g., FeCo) surrounding internal relatively low magnetic permeability region 72 (e.g., Fe or FeSi). In a refinement, magnetic pole piece 32 includes a region 74 that is non-magnetic (i.e., low permeability), such as a space, stainless steel, etc. FIG. 4B depicts a configuration in which magnetic pole piece 26 and magnetic pole piece 32 have curved surfaces 80 and 82, respectively, proximate cavity 14. This configuration produces a permanent magnet 84 with curved surfaces. This configuration can also produce a permanent magnet 86 with an annular shape with a region 88 not having magnetizable powder.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for manufacturing a spatially varying permanent magnet with enhanced demagnetization resistance, the method comprising:
placing magnetic particles of a magnetizable material in an alignment fixture that is position between a first magnetic pole piece and a second magnetic pole piece of an electromagnet;
configuring at least one of the first magnetic pole piece and the second magnetic pole piece to include regions with spatially varying magnetic permeabilities, wherein the magnetic permeability of the first magnetic pole piece and/or the second magnetic pole piece modifies orientation and magnitude of a magnetic field in the alignment fixture;
aligning the magnetic particles in different regions of the magnetizable material according to an orientation and magnitude of the magnetic field by activating the electromagnet; and
forming the spatially varying permanent magnet.

2. The method of claim 1, wherein the spatially varying permanent magnet includes inclined easy axis regions such that the spatially varying permanent magnet has a magnetic resistance to demagnetization relative to a spatially uniform magnet.

3. The method of claim 2, wherein an inclination angle of an inclined easy axis relative to a normal to a predefined surface of the permanent magnet is at least 15 degrees, the predefined surface being a surface facing the first magnetic pole piece and/or the second magnetic pole piece.

4. The method of claim 1, wherein a magnetic permeability of the first magnetic pole piece and/or the second magnetic pole piece is configured with regions in a parallel and/or a serial arrangement to control magnetic field distribution in the alignment fixture.

5. The method of claim 1 further comprising configuring the first magnetic pole piece and/or the second magnetic pole piece to generate a periodically varying magnetic field within the alignment fixture, thereby producing a permanent magnet with a sinusoidal variation in flux density.

6. The method of claim 1, wherein the magnetic field is adjusted to produce a permanent magnet with varied shapes and magnetic properties.

7. The method of claim 1, wherein the spatially varying permanent magnet is formed using a sintering process after alignment of the magnetic particles.

8. The method of claim 1, wherein the first magnetic pole piece and/or the second magnetic pole piece include regions with a first magnetic permeability and regions with a second magnetic permeability which can generate a spatially varying magnetic field, the first magnetic permeability being lower than the second magnetic permeability.

9. The method of claim 8, wherein the magnetic particles with a relatively low magnetic permeability include FeSi alloys, soft magnetic composite alloys, or amorphous Fe based alloys.

10. The method of claim 8, wherein magnetic particles with a relatively high magnetic permeability include iron (Fe), iron-cobalt (FeCo) alloys, and combinations thereof.

11. A fixture for aligning magnetic particles while forming a spatially varying permanent magnet, the fixture comprising:
an alignment cavity configured to hold magnetizable material in a powder form;
at least one electromagnet having a first magnetic pole piece and a second magnetic pole piece, wherein one or both of the first magnetic pole piece and the second magnetic pole piece are constructed from materials with varying magnetic permeabilities, wherein the first magnetic pole piece and the second magnetic pole piece are arranged about the alignment cavity, the first magnetic pole piece and the second magnetic pole piece being arranged to control orientation and magnitude of a magnetic field within the alignment cavity; and
wherein the first magnetic pole piece and the second magnetic pole piece are configured to produce a spatially varying magnetic field in the alignment cavity, resulting in the alignment of magnetic particles with a spatially varying orientation corresponding to a magnetic field distribution.

12. The fixture of claim 11, wherein the first magnetic pole piece and/or the second magnetic pole piece include regions with a first magnetic permeability and regions with a second magnetic permeability which can generate a spatially varying magnetic field, the first magnetic permeability being lower than the second magnetic permeability.

13. The fixture of claim 12, wherein magnetic regions with a relatively low magnetic permeability include FeSi alloys, soft magnetic composite alloys, or amorphous Fe based alloys.

14. The fixture of claim 13, wherein magnetic particles with a relatively high magnetic permeability include iron (Fe), iron-cobalt (FeCo) alloys, and combinations thereof.

15. The fixture of claim 11, wherein a magnetic permeability of the first magnetic pole piece and/or the second magnetic pole piece is configured with regions in a parallel and/or a serial arrangement to control the magnetic field distribution in the alignment cavity.

16. The fixture of claim 11, wherein the first magnetic pole piece and/or the second magnetic pole piece are configured to create a periodically varying magnetic field in the alignment cavity, thereby producing a sinusoidal or other periodic flux variation in the aligned magnetic particles.

17. The fixture of claim 11, wherein the alignment cavity is designed to accommodate different magnet shapes and sizes, allowing formation of magnets with varied geometries and spatially tailored magnetic properties.

18. The fixture of claim 11, wherein the first magnetic pole piece and/or the second magnetic pole piece are configured to generate an inclined magnetic field in selected regions of the alignment cavity, resulting in formation of an inclined easy axis in the spatially varying permanent magnet.

19. A spatially varying permanent magnet comprising:
a sintered plurality of magnetic particles aligned using an electromagnet having pole pieces configured with materials of spatially varying magnetic permeabilities, wherein at least one region of the spatially varying permanent magnet has an easy axis of at least 15 degrees with respect to a surface normal such that the spatially varying permanent magnet includes a demagnetization resistance in regions of the spatially varying permanent magnet exposed to higher demagnetizing fields.

20. The spatially varying permanent magnet of claim 19, wherein the sintered plurality of magnetic particles includes magnetically anisotropic regions.
